(19) United States
(12) Patent Application Publication
(10) Pub. No.: US 2017/0214488 A1
(43) Pub. Date: Jul. 27, 2017

(54) SUPERCHANNELS WITH MIXED BAUD RATE SUBCARRIERS

(71) Applicant: Fujitsu Limited, Kawasaki-shi (JP)

(72) Inventors: Olga Vassilieva, Plano, TX (US); Inwoong Kim, Allen, TX (US); Motoyoshi Sekiya, Kanagawa (JP)

(21) Appl. No.: 15/007,586

(22) Filed: Jan. 27, 2016

(51) Int. Cl. H04L 1/00; H04B 10/50

(52) U.S. Cl. CPC H04L 1/0041; H04B 10/50

(57) ABSTRACT

Methods and systems for transmitting superchannels with mixed baud rate subcarriers include modifying baud rates for certain subcarriers in order to improve or equalize optical signal-to-noise ratio penalties incurred during transmission. Additionally frequency shifts may be applied to individual subcarriers. The baud rate modification and frequency shifts may be symmetrical for spectral positions of subcarriers within the superchannel.

### BACKGROUND

Field of the Disclosure

The present disclosure relates generally to optical communication networks and, more particularly, to superchannels with mixed baud rate subcarriers.

Description of the Related Art

Telecommunications systems, cable television systems and data communication networks use optical networks to rapidly convey large amounts of information between remote points. In an optical network, information is conveyed in the form of optical signals through optical fibers. Optical networks may also include various network nodes such as amplifiers, dispersion compensators, multiplexer/demultiplexer filters, wavelength selective switches, couplers, etc. to perform various operations within the network.

Optical superchannels are an emerging solution for transmission of signals at 400 Gb/s and 1 Tb/s data rate per channel, and hold promise for even higher data rates in the future. A typical superchannel includes a set of subcarriers that are frequency multiplexed to form a single wavelength channel. The superchannel may then be transmitted through an optical network as a single channel across network endpoints. The subcarriers within the superchannel are tightly packed to achieve high spectral efficiency.

### SUMMARY

In one aspect, a disclosed method is for transmission of superchannels with mixed baud rate subcarriers. The method may include, for a superchannel being transmitted over an optical transmission path, modifying a baud rate for at least one subcarrier included in the superchannel. After the modifying, the method may include transmitting the superchannel over the optical transmission path, such that at least two subcarriers in the superchannel may have different baud rates.

In any of the disclosed embodiments of the method, the modifying the baud rate may further include using a forward error correction module to modify the baud rate.

In any of the disclosed embodiments of the method, the modifying the baud rate may further include using an optical transmitter to modify the baud rate.

In any of the disclosed embodiments of the method, the modifying the baud rate may further include decreasing the baud rate. In any of the disclosed embodiments of the method, the modifying the baud rate may further include increasing the baud rate.

In any of the disclosed embodiments of the method, the modifying the baud rate may further include decreasing an overall baud rate for the superchannel. In any of the disclosed embodiments of the method, the modifying the baud rate may further include maintaining an overall baud rate for the superchannel.

In any of the disclosed embodiments of the method, the modifying the baud rate may depend upon a spectral position of a subcarrier in the superchannel. In any of the disclosed embodiments of the method, the modifying the baud rate may further include modifying the baud rate symmetrically with respect to spectral positions of the subcarriers within the superchannel. In any of the disclosed embodiments of the method, the modifying the baud rate may further include setting the baud rate for a subcarrier band comprising at least two spectrally adjacent subcarriers.

In another aspect, a disclosed optical transport network is for transmitting superchannels with mixed baud rate subcarriers. The optical transport network may include an optical transmission path, including an optical transmitter and an optical receiver, for transmitting a superchannel. In the optical transport network, a baud rate may be modified for at least one subcarrier included in the superchannel. After the baud rate is modified in the optical transport network, at least two subcarriers in the superchannel may have different baud rates.

In any of the disclosed embodiments of the optical transport network, the baud rate may be modified using a forward error correction module prior to the optical transmitter along the optical transmission path. In any of the disclosed embodiments of the optical transport network, the baud rate may be modified using the optical transmitter.

In any of the disclosed embodiments of the optical transport network, the baud rate may be modified to decrease the baud rate. In any of the disclosed embodiments of the optical transport network, the baud rate may be modified to increase the baud rate.

In any of the disclosed embodiments of the optical transport network, after the baud rate is modified, an overall baud rate for the superchannel may be decreased. In any of the disclosed embodiments of the optical transport network, after the baud rate is modified, an overall baud rate for the superchannel may be maintained.

In any of the disclosed embodiments of the optical transport network, the baud rate may be modified based upon a spectral position of a subcarrier in the superchannel. In any of the disclosed embodiments of the optical transport network, the baud rate may be modified symmetrically with respect to spectral positions of the subcarriers within the superchannel. In any of the disclosed embodiments of the optical transport network, the baud rate may be modified to set the baud rate for a subcarrier band comprising at least two spectrally adjacent subcarriers.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram of selected elements of an embodiment of an optical transport network;

FIG. 2 shows selected elements of an embodiment of a superchannel power spectrum;

FIG. 3 is a block diagram of selected elements of an embodiment of an optical control plane system for superchannel subcarrier monitoring;

FIGS. 4A, 4B, 5, 6, and 7 are selected elements of embodiments of superchannel power spectra; and

FIG. 8 is a flow chart of selected elements of a method for transmitting superchannels with mixed baud rate subcarriers.

### DESCRIPTION OF THE EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

In the following description, details are set forth by way of example to facilitate discussion of the disclosed subject matter. It should be apparent to a person of ordinary skill in the field, however, that the disclosed embodiments are exemplary and not exhaustive of all possible embodiments.

As used herein, a hyphenated form of a reference numeral refers to a specific instance of an element and the un-hyphenated form of the reference numeral refers to the collective or generic element. Thus, for example, widget “72-1” refers to an instance of a widget class, which may be referred to collectively as widgets “72” and any one of which may be referred to generically as a widget “72”.

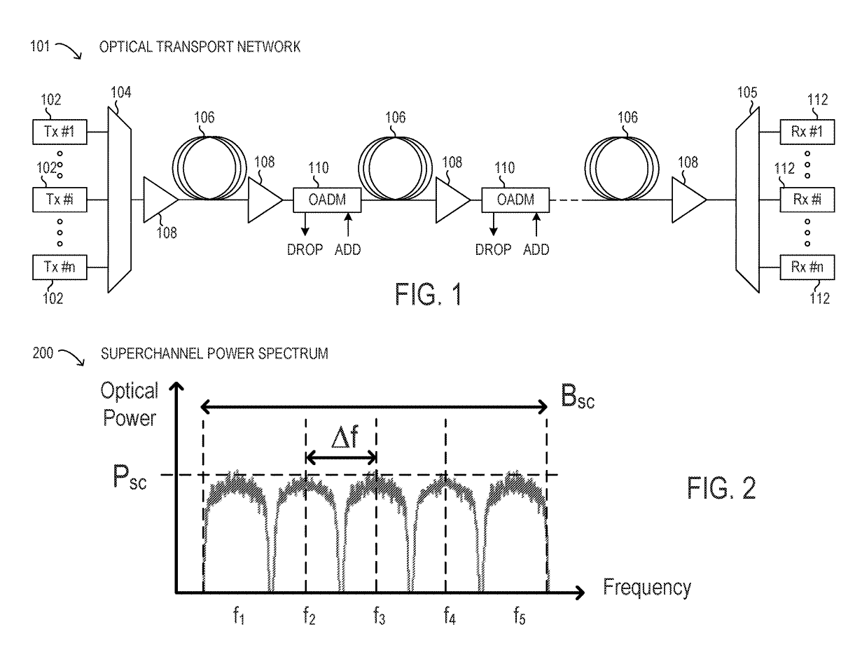

Referring now to the drawings, FIG. 1 illustrates an example embodiment of optical transport network (OTN) 101, which may represent an optical communication system. Optical transport network 101 included one or more optical fibers 106 to transport one or more optical signals communicated by components of optical transport network 101. The network elements of optical transport network 101, coupled together by fibers 106, may comprise one or more transmitters (Tx) 102, one or more multiplexers (MUX) 104, one or more optical amplifiers 108, one or more optical add/drop multiplexers (OADM) 110, one or more demultiplexers (DEMUX) 105, and one or more receivers (Rx) 112.

Optical transport network 101 may comprise a point-to-point optical network with terminal nodes, a ring optical network, a mesh optical network, or any other suitable optical network or combination of optical networks. Optical transport network 101 may be used in a short-haul metropolitan network, a long-haul inter-city network, or any other suitable network or combination of networks. The capacity of optical transport network 101 may include, for example, 100 Gbit/s, 400 Gbit/s, or 1 Tbit/s. Optical fibers 106 comprise thin strands of glass capable of communicating the signals over long distances with very low loss. Optical fibers 106 may comprise a suitable type of fiber selected from a variety of different fibers for optical transmission. Optical fibers 106 may include any suitable type of fiber, such as a standard Single-Mode Fiber (SMF), Enhanced Large Effective Area Fiber (E-LEAF), or TrueWave® Reduced Slope (TW-RS) fiber.

Optical transport network 101 may include devices to transmit optical signals over optical fibers 106. Information may be transmitted and received through optical transport network 101 by modulation of one or more wavelengths of light to encode the information on the wavelength. In optical networking, a wavelength of light may also be referred to as a “channel” that is included in an optical signal. Each channel may carry a certain amount of information through optical transport network 101.

To increase the information capacity and transport capabilities of optical transport network 101, multiple signals transmitted at multiple channels may be combined into a single wide bandwidth optical signal. The process of communicating information at multiple channels is referred to in optics as wavelength division multiplexing (WDM). Coarse wavelength division multiplexing (CWDM) refers to the multiplexing of wavelengths that are widely spaced having low number of channels, usually greater than 20 nm and less than sixteen wavelengths, and dense wavelength division multiplexing (DWDM) refers to the multiplexing of wavelengths that are closely spaced having large number of channels, usually less than 0.8 nm spacing and greater than forty wavelengths, into a fiber. WDM or other multi-wavelength multiplexing transmission techniques are employed in optical networks to increase the aggregate bandwidth per optical fiber. Without WDM, the bandwidth in optical networks may be limited to the bit-rate of solely one wavelength. With more bandwidth, optical networks are capable of transmitting greater amounts of information. Optical transport network 101 may transmit disparate channels using WDM or some other suitable multi-channel multiplexing technique, and to amplify the multi-channel signal.

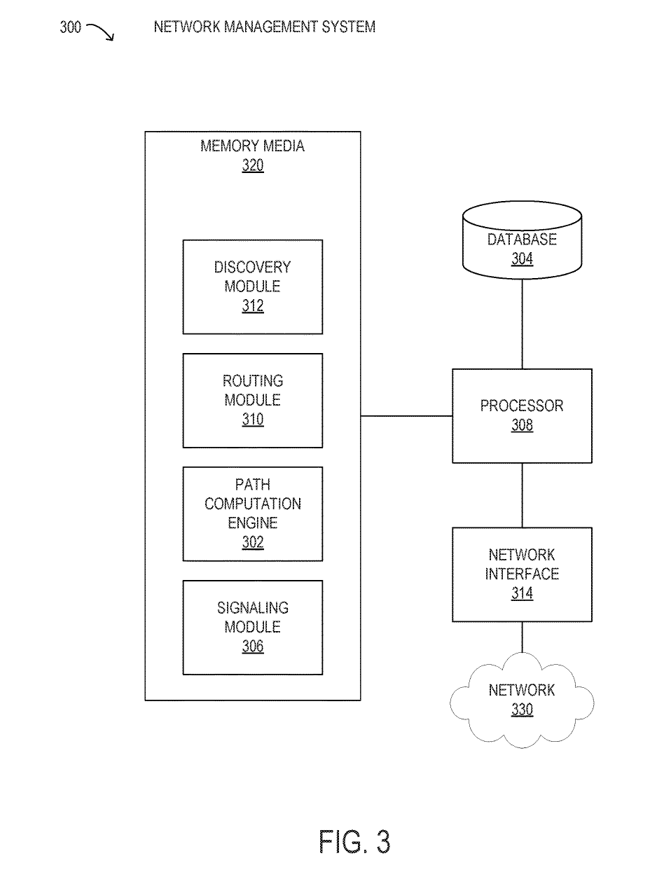

Recently, advancements in DWDM enabled combining several optical carriers to create a composite optical signal of a desired capacity. One such example of a multi-carrier optical signal is a superchannel, which is an example of high spectral efficiency (SE) that may attain transmission rates of 100 Gb/s, 400 Gb/s, 1 Tb/s, or higher. Thus, in a superchannel, subcarriers are tightly packed and consume less optical spectrum than in conventional DWDM. Another distinctive feature of superchannels is that the subcarriers in a superchannel travel from the same origin to the same destination, and are not added or removed using an OADM while in transmission. Techniques for achieving high spectral efficiency (SE) in optical networks may include the use of superchannels modulated using dual-polarization quadrature phase-shift keying (DP-QPSK) for long-haul transmission at data rates of 100 Gb/s or greater. In particular embodiments, Nyquist wavelength-division multiplexing (N-WDM) may be used in a superchannel. In N-WDM, optical pulses having a nearly rectangular spectrum are packed together in the frequency domain with a bandwidth approaching the baud rate (see also FIG. 2).

Optical transport network 101 may include one or more optical transmitters (Tx) 102 to transmit optical signals through optical transport network 101 in specific wavelengths or channels. Transmitters 102 may comprise a system, apparatus or device to convert an electrical signal into an optical signal and transmit the optical signal. For example, transmitters 102 may each comprise a laser and a modulator to receive electrical signals and modulate the information contained in the electrical signals onto a beam of light produced by the laser at a particular wavelength, and transmit the beam for carrying the signal throughout optical transport network 101. In some embodiments, optical transmitter 102 may be used to determine the baud rate for the data to be transmitted during the optical modulation. An example of transmitter 102 for applying different baud rates is an adaptive rate transponder. Additionally, a forward error correction (FEC) module may be included in optical transmitter 102, or may be used in conjunction with optical transmitter 102. The FEC module may process the electrical signal carrying the information or data to be transmitted to include error correction codes. The FEC module at transmitter 102 may also determine a baud rate for sending the data to be transmitted to optical transmitter 102 for optical modulation.

Multiplexer 104 may be coupled to transmitters 102 and may be a system, apparatus or device to combine the signals transmitted by transmitters 102, e.g., at respective individual wavelengths, into a WDM signal.

Optical amplifiers 108 may amplify the multi-channeled signals within optical transport network 101. Optical amplifiers 108 may be positioned before and after certain lengths of fiber 106, which is referred to as “in-line amplification”. Optical amplifiers 108 may comprise a system, apparatus, or device to amplify optical signals. For example, optical amplifiers 108 may comprise an optical repeater that amplifies the optical signal. This amplification may be performed with opto-electrical or electro-optical conversion. In some embodiments, optical amplifiers 108 may comprise an optical fiber doped with a rare-earth element to form a doped fiber amplification element. When a signal passes through the fiber, external energy may be applied in the form of a pump signal to excite the atoms of the doped portion of the optical fiber, which increases the intensity of the optical signal. As an example, optical amplifiers 108 may comprise an erbium-doped fiber amplifier (EDFA). However, any other suitable amplifier, such as a semiconductor optical amplifier (SOA), may be used.

OADMs 110 may be coupled to optical transport network 101 via fibers 106. OADMs 110 comprise an add/drop module, which may include a system, apparatus or device to add and drop optical signals (i.e., at individual wavelengths) from fibers 106. After passing through an OADM 110, an optical signal may travel along fibers 106 directly to a destination, or the signal may be passed through one or more additional OADMs 110 and optical amplifiers 108 before reaching a destination. In this manner, OADMs 110 may enable connection of different optical transport network topologies together, such as different rings and different linear spans.

In certain embodiments of optical transport network 101, OADM 110 may represent a reconfigurable OADM (ROADM) that is capable of adding or dropping individual or multiple wavelengths of a WDM signal. The individual or multiple wavelengths may be added or dropped in the optical domain, for example, using a wavelength selective switch (WSS) (not shown) that may be included in a ROADM.

Many existing optical networks are operated at 10 gigabit-per-second (Gbps) or 40 Gbps signal rates with 50 gigahertz (GHz) of channel spacing in accordance with International Telecommunications Union (ITU) standard wavelength grids, also known as fixed-grid spacing, which is compatible with conventional implementations of optical add-drop multiplexers (OADMs) and with conventional implementations of demultiplexers 105. However, as data rates increase to 100 Gbps and beyond, the wider spectrum requirements of such higher data rate signals often require increasing channel spacing. In traditional fixed grid networking systems supporting signals of different rates, the entire network system typically must be operated with the coarsest channel spacing (100 GHz, 200 GHz, etc.) that can accommodate the highest rate signals. This may lead to an over-provisioned channel spectrum for lower-rate signals and lower overall spectrum utilization.

Thus, in certain embodiments, optical transport network 101 may employ components compatible with flexible grid optical networking that enables specifying a particular frequency slot per channel. For example, each wavelength channel of a WDM transmission may be allocated using at least one frequency slot. Accordingly, one frequency slot may be assigned to a wavelength channel whose symbol rate is low, while a plurality of frequency slots may be assigned to a wavelength channel whose symbol rate is high. Thus, in optical transport network 101, ROADM 110 may be capable of adding or dropping individual or multiple wavelengths of a WDM, DWDM, or superchannel signal carrying data channels to be added or dropped in the optical domain. In certain embodiments, ROADM 110 may include or be coupled to a wavelength selective switch (WSS).

As shown in FIG. 1, optical transport network 101 may also include one or more demultiplexers 105 at one or more destinations of network 101. Demultiplexer 105 may comprise a system apparatus or device that acts as a demultiplexer by splitting a single composite WDM signal into individual channels at respective wavelengths. For example, optical transport network 101 may transmit and carry a forty (40) channel DWDM signal. Demultiplexer 105 may divide the single, forty channel DWDM signal into forty separate signals according to the forty different channels. It will be understood that different numbers of channels or subcarriers may be transmitted and demultiplexed in optical transport network 101, in various embodiments.

In FIG. 1, optical transport network 101 may also include receivers 112 coupled to demultiplexer 105. Each receiver 112 may receive optical signals transmitted at a particular wavelength or channel, and may process the optical signals to obtain (demodulate) the information (data) that the optical signals contain. Accordingly, network 101 may include at least one receiver 112 for every channel of the network. As shown, receivers 112 may demodulate the optical signals according to a baud rate used by transmitter 102. In some embodiments, receiver 112 may include, or may be followed by, a forward error correction (FEC) module to use the error correction codes to check the integrity of the received data. The FEC module may also correct certain errors in the data based on the error correction codes. The FEC module at receiver 112 may also demodulate the data at a specific baud rate defined for each channel at transmitter 102, as described above.

Optical networks, such as optical transport network 101 in FIG. 1, may employ modulation techniques to convey information in the optical signals over the optical fibers. Such modulation schemes may include phase-shift keying (PSK), frequency-shift keying (FSK), amplitude-shift keying (ASK), and quadrature amplitude modulation (QAM), among other examples of modulation techniques. In PSK, the information carried by the optical signal may be conveyed by modulating the phase of a reference signal, also known as a carrier wave, or simply, a carrier. The information may be conveyed by modulating the phase of the signal itself using two-level or binary phase-shift keying (BPSK), four-level or quadrature phase-shift keying (QPSK), multi-level phase-shift keying (M-PSK) and differential phase-shift keying (DPSK). In QAM, the information carried by the optical signal may be conveyed by modulating both the amplitude and phase of the carrier wave. PSK may be considered a subset of QAM, wherein the amplitude of the carrier waves is maintained as a constant.

PSK and QAM signals may be represented using a complex plane with real and imaginary axes on a constellation diagram. The points on the constellation diagram representing symbols carrying information may be positioned with uniform angular spacing around the origin of the diagram. The number of symbols to be modulated using PSK and QAM may be increased and thus increase the information that can be carried. The number of signals may be given in multiples of two. As additional symbols are added, they may be arranged in uniform fashion around the origin. PSK signals may include such an arrangement in a circle on the constellation diagram, meaning that PSK signals have constant power for all symbols. QAM signals may have the same angular arrangement as that of PSK signals, but include different amplitude arrangements. QAM signals may have their symbols arranged around multiple circles, meaning that the QAM signals include different power for different symbols. This arrangement may decrease the risk of noise as the symbols are separated by as much distance as possible. A number of symbols “m” may thus be used and denoted “m-PSK” or “m-QAM.”

Examples of PSK and QAM with a different number of symbols can include binary PSK (BPSK or 2-PSK) using two phases at 0° and 180° (or in radians, 0 and π) on the constellation diagram; or quadrature PSK (QPSK, 4-PSK, or 4-QAM) using four phases at 0°, 90°, 180°, and 270° (or in radians, 0, π/2, π, and 3π/2). Phases in such signals may be offset. Each of 2-PSK and 4-PSK signals may be arranged on the constellation diagram. Certain m-PSK signals may also be polarized using techniques such as dual-polarization QPSK (DP-QPSK), wherein separate m-PSK signals are multiplexed by orthogonally polarizing the signals. Also, m-QAM signals may be polarized using techniques such as dual-polarization 16-QAM (DP-16-QAM), wherein separate m-QAM signals are multiplexed by orthogonally polarizing the signals.

Dual polarization technology, which may also be referred to as polarization division multiplexing (PDM), enables achieving a greater bit rate for information transmission. PDM transmission comprises simultaneously modulating information onto various polarization components of an optical signal associated with a channel, thereby nominally increasing the transmission rate by a factor of the number of polarization components. The polarization of an optical signal may refer to the direction of the oscillations of the optical signal. The term “polarization” may generally refer to the path traced out by the tip of the electric field vector at a point in space, which is perpendicular to the propagation direction of the optical signal.

In certain embodiments, optical transport network 101 may transmit a superchannel, in which a plurality of subcarriers (or subchannels or channels) are densely packed in a fixed bandwidth band and may be transmitted at very high data rates, such as 400 Gb/s, 1 Tb/s, or higher. Furthermore, the superchannel may be well suited for transmission over very long distances, such as hundreds of kilometers, for example. A typical superchannel may comprise a set of subcarriers that are frequency multiplexed to form a single channel that are transmitted through optical transport network 101 as one entity. The subcarriers within the superchannel may be tightly packed to achieve high spectral efficiency.

In an optical network, such as optical transport network 101 in FIG. 1, it is typical to refer to a management plane, a control plane, and a transport plane (sometimes called the physical layer). A central management host (not shown) may reside in the management plane and may configure and supervise the components of the control plane. The management plane includes ultimate control over all transport plane and control plane entities (e.g., network elements). As an example, the management plane may consist of a central processing center (e.g., the central management host), including one or more processing resources, data storage components, etc. The management plane may be in electrical communication with the elements of the control plane and may also be in electrical communication with one or more network elements of the transport plane. The management plane may perform management functions for an overall system and provide coordination between network elements, the control plane, and the transport plane. As examples, the management plane may include an element management system (EMS) which handles one or more network elements from the perspective of the elements, a network management system (NMS) which handles many devices from the perspective of the network, or an operational support system (OSS) which handles network-wide operations.

Modifications, additions or omissions may be made to optical transport network 101 without departing from the scope of the disclosure. For example, optical transport network 101 may include more or fewer elements than those depicted in FIG. 1. Also, as mentioned above, although depicted as a point-to-point network, optical transport network 101 may comprise any suitable network topology for transmitting optical signals such as a ring, a mesh, or a hierarchical network topology.

In operation, optical transport network 101 may be used to transmit a superchannel, in which a plurality of subcarrier signals are densely packed in a fixed bandwidth band and may be transmitted at very high data rates, such as 400 Gb/s, 1 Tb/s, or higher. As noted above, optical superchannels may represent a promising solution for transmission of signals at 400 Gb/s and 1 Tb/s data rate per channel. In order to minimize linear crosstalk between neighboring subcarriers in the superchannel, Nyquist filtering may be applied at the transmitter side to shape the subcarrier frequency bands (see also FIG. 2). Various transmission experiments with superchannels have revealed that each subcarrier within a superchannel may experience different amounts of linear and nonlinear interactions with neighboring subcarriers (crosstalk), resulting in different received OSNR penalties. It has been reported that subcarriers in a superchannel may exhibit different degrees of bit rate error (BER), and accordingly OSNR, which may be observed at receivers 112. For example, subcarriers in a central band of the superchannel may suffer from larger BER due to nonlinear interaction compared to subcarriers in an edge band of the superchannel. Such a variance in BER among the subcarriers of a superchannel may be undesirable for an operator of optical transport network 101. The operator (or network service provider) of optical transport network 101 may desire uniform performance for every transmitted channel for operational and economic reasons. Furthermore, when a superchannel is transmitted through one or more ROADM nodes, the edge subcarriers in the superchannel may suffer degradation resulting from passband narrowing (PBN).

As will be described in further detail herein, methods and systems are disclosed for transmitting superchannels using mixed baud rate subcarriers, instead of using a uniform baud rate for all subcarriers. Because lower baud rate subcarriers have a higher tolerance to fiber nonlinearity, selectively reducing the baud rate of certain subcarriers may reduce, or equalize, OSNR penalties within the superchannel.

Referring to FIG. 2, selected elements of an embodiment of a superchannel is shown as superchannel power spectrum 200, which depicts five (5) subcarriers. While the data used for superchannel power spectrum 200 are not actual measured values, the illustrated power spectrum may be characteristic of an actual superchannel. In superchannel power spectrum 200, the subcarriers may each be modulated with 200 GB/s DP-16-QAM signals. Furthermore, each subcarrier band has been subject to electrical Nyquist pulse shaping in the transmitter using a root raised cosine method using a roll-off factor of 0.15. As shown in FIG. 2, B_{SC} represents the fixed superchannel transmission band, while Δf represents the subcarrier frequency spacing. In certain embodiments, the subcarrier frequency spacing Δf may be 35 GHz and may be uniform between each center frequency f₁, f₂, f₃, f₄, and f₅, respectively corresponding to the subcarriers. The subcarrier frequency spacing Δf may be selected to be wide enough to prevent any significant linear crosstalk between adjacent subcarriers. The optical signal of each subcarrier may be multiplexed using an optical coupler to form the single superchannel in the fixed transmission band B_{SC} having an aggregate data rate of 1 Tb/s, for example. It is noted that different values for the fixed superchannel transmission band, B_{SC}, the subcarrier frequency spacing Δf, and the overall aggregate data rate may result in superchannel power spectrum 200. Also shown in FIG. 2 is constant power level, P_{SC}, that is a power level for the superchannel that is substantially similar or equal for each of the 5 subcarriers, such that P_{SC}, may correspond to an average power level for each of the subcarriers.

In typical DWDM networks, it is known that system performance may depend on an allocation of each wavelength channel on the wavelength grid, such that a longer wavelength channel may suffer from smaller nonlinear impairments compared to a shorter wavelength channel. In case of superchannel-based WDM systems, in addition to the wavelength dependency of the subcarrier error rate across the transmission band, such as the C-band, a dependency of individual subcarrier error rate (or OSNR at the receiver) on spectral allocation of the subcarrier within the superchannel has now been observed in the form of nonlinear impairments (such as cross-talk). Linear cross-talk may be observed between two adjacent subcarriers (inter-subcarrier) and may depend on a degree or extent of overlap in the frequency domain of the adjacent subcarriers. The use of Nyquist pulse shaping, as shown in FIG. 2, may represent an effective means for maintaining a minimum level of linear cross-talk between adjacent subcarriers, at least in part due to the nearly vertical edges of the Nyquist-shaped subcarriers (spectral pulses) that do not substantially overlap each other in the frequency domain. Non-linear cross-talk may also be observed and may arise from nonlinear interactions during fiber transmission.

The nonlinear interactions may include phenomena such as cross-phase modulation (XPM), self-phase modulation (SPM), and four-wave mixing, among others. Cross-phase modulation may occur when phase information, amplitude information, or both from one channel is modulated to an adjacent channel in the superchannel. Self-phase modulation may arise when a variation in the refractive index (or a dependency of the refractive index on intensity) results in a phase shift within each subcarrier. In four-wave mixing, three wavelengths may interact to create a fourth wavelength that may coincide with a wavelength of a subcarrier, and may lead to undesirable variations in peak power or other types of signal distortion on the affected subcarrier. Furthermore, nonlinear cross-talk may comprise inter-subcarrier components. Since nonlinear interactions occur during fiber transmission and may not depend on a degree of overlap of the subcarrier frequency bands, Nyquist pulse shaping may be ineffective in resolving certain problems with nonlinear cross-talk in a superchannel.

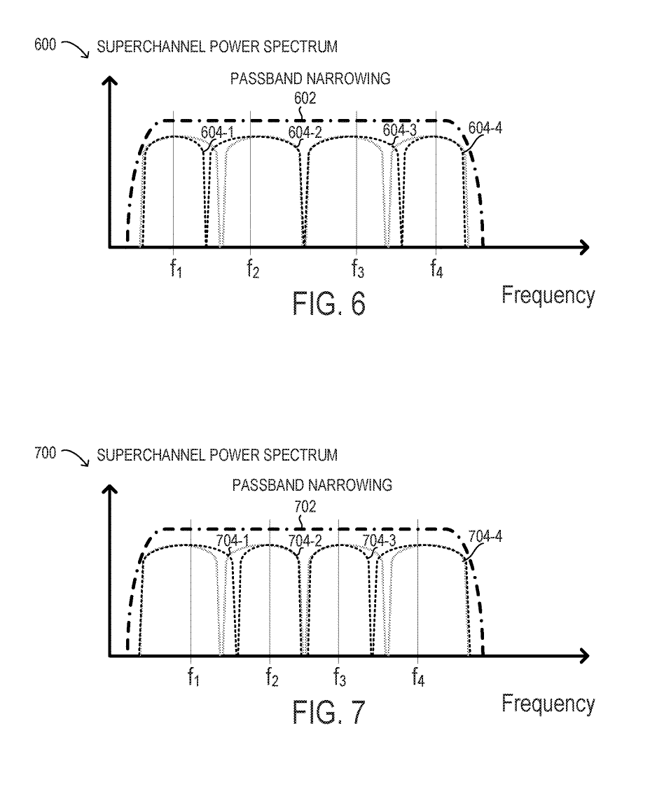

For single superchannels, at least some of the subcarriers depicted in simulated frequency spectrum 200 may be modified with a different baud rate to reduce the variation in OSNR between the individual subcarrier. As noted, when a superchannel is transmitted through one or more ROADM nodes, the edge subcarriers in the superchannel may suffer degradation resulting from PBN. In such cases, for example, the baud rate of edge subcarriers may be decreased to accommodate PBN, by reducing Bsc (see FIG. 4A). In other examples, other subcarriers in the superchannel may be spectrally narrowed by decreasing the baud rate. In some cases, some subcarriers may be transmitted with an increased baud rate, while other subcarriers are transmitted with a reduced baud rate, such that Bsc does not change when mixed baud rate subcarriers are transmitted in a superchannel.

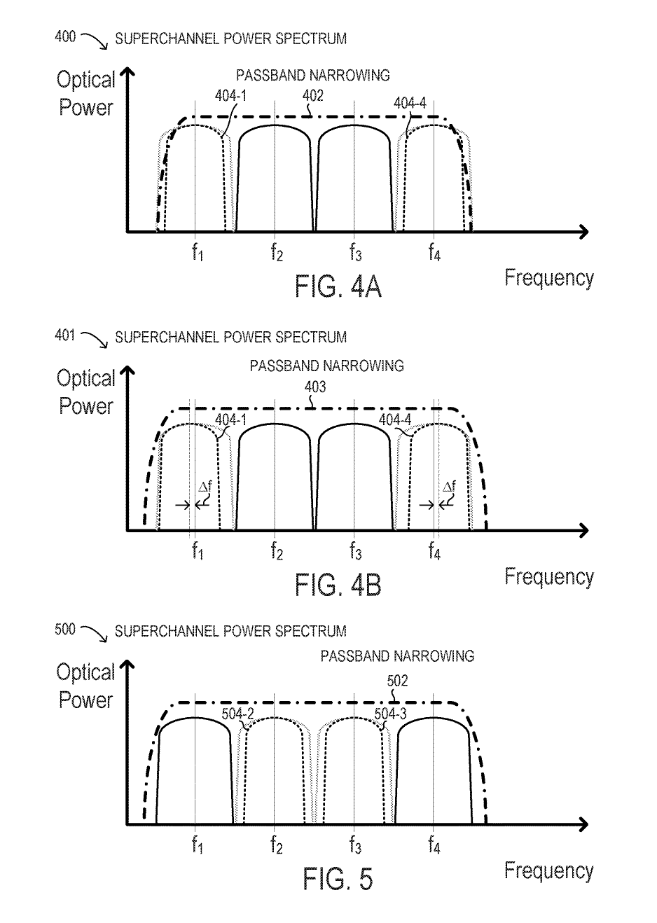

Referring now to FIG. 3, a block diagram of selected elements of an embodiment of control system 300 for implementing control plane functionality in optical networks, such as, for example, in optical transport network 101 (see FIG. 1), is illustrated. A control plane may include functionality for network intelligence and control and may comprise applications that support the ability to establish network services, including applications or modules for discovery, routing, path computation, and signaling, as will be described in further detail. The control plane applications executed by control system 300 may work together to automatically establish services within the optical network. Discovery module 312 may discover local links connecting to neighbors. Routing module 310 may broadcast local link information to optical network nodes while populating database 304. When a request for service from the optical network is received, path computation engine 302 may be called to compute a network path using database 304. This network path may then be provided to signaling module 306 to establish the requested service.

As shown in FIG. 3, control system 300 includes processor 308 and memory media 320, which may store executable instructions (i.e., executable code) that may be executable by processor 308, which has access to memory media 320. Processor 308 may execute instructions that cause control system 300 to perform the functions and operations described herein. For the purposes of this disclosure, memory media 320 may include non-transitory computer-readable media that stores data and instructions for at least a period of time. Memory media 320 may comprise persistent and volatile media, fixed and removable media, and magnetic and semiconductor media. Memory media 320 may include, without limitation, storage media such as a direct access storage device (e.g., a hard disk drive or floppy disk), a sequential access storage device (e.g., a tape disk drive), compact disk (CD), random access memory (RAM), read-only memory (ROM), CD-ROM, digital versatile disc (DVD), electrically erasable programmable read-only memory (EEPROM), and flash memory; non-transitory media, or various combinations of the foregoing. Memory media 320 is operable to store instructions, data, or both. Memory media 320 as shown includes sets or sequences of instructions that may represent executable computer programs, namely, path computation engine 302, signaling module 306, discovery module 312, and routing module 310.

Also shown included with control system 300 in FIG. 3 is network interface 314, which may be a suitable system, apparatus, or device operable to serve as an interface between processor 308 and network 330. Network interface 314 may enable control system 300 to communicate over network 330 using a suitable transmission protocol or standard. In some embodiments, network interface 314 may be communicatively coupled via network 330 to a network storage resource. In some embodiments, network 330 represents at least certain portions of optical transport network 101. Network 330 may also include certain portions of a network using galvanic or electronic media. In certain embodiments, network 330 may include at least certain portions of a public network, such as the Internet. Network 330 may be implemented using hardware, software, or various combinations thereof.

In certain embodiments, control system 300 may be configured to interface with a person (a user) and receive data about the optical signal transmission path. For example, control system 300 may also include or may be coupled to one or more input devices and output devices to facilitate receiving data about the optical signal transmission path from the user and to output results to the user. The one or more input or output devices (not shown) may include, but are not limited to, a keyboard, a mouse, a touchpad, a microphone, a display, a touchscreen display, an audio speaker, or the like. Alternately or additionally, control system 300 may be configured to receive data about the optical signal transmission path from a device such as another computing device or a network element, for example via network 330.

As shown in FIG. 3, in some embodiments, discovery module 312 may be configured to receive data concerning an optical signal transmission path in an optical network and may be responsible for discovery of neighbors and links between neighbors. In other words, discovery module 312 may send discovery messages according to a discovery protocol, and may receive data about the optical signal transmission path. In some embodiments, discovery module 312 may determine features, such as, but not limited to: fiber type, fiber length, number and type of components, data rate, modulation format of the data, input power of the optical signal, number of signal carrying wavelengths (i.e., channels), channel spacing, traffic demand, and network topology, among others.

As shown in FIG. 3, routing module 310 may be responsible for propagating link connectivity information to various nodes within an optical network, such as optical transport network 101. In particular embodiments, routing module 310 may populate database 304 with resource information to support traffic engineering, which may include link bandwidth availability. Accordingly, database 304 may be populated by routing module 310 with information usable to determine a network topology of an optical network.

Path computation engine 302 may be configured to use the information provided by routing module 310 to database 304 to determine transmission characteristics of the optical signal transmission path. The transmission characteristics of the optical signal transmission path may provide insight on how transmission degradation factors, such as chromatic dispersion (CD), nonlinear (NL) effects, polarization effects, such as polarization mode dispersion (PMD) and polarization dependent loss (PDL), and amplified spontaneous emission (ASE), among others, may affect optical signals within the optical signal transmission path. To determine the transmission characteristics of the optical signal transmission path, path computation engine 302 may consider the interplay between the transmission degradation factors. In various embodiments, path computation engine 302 may generate values for specific transmission degradation factors. Path computation engine 302 may further store data describing the optical signal transmission path in database 304.

In FIG. 3, signaling module 306 may provide functionality associated with setting up, modifying, and tearing down end-to-end networks services in an optical network, such as optical transport network 101. For example, when an ingress node in the optical network receives a service request, control system 300 may employ signaling module 306 to request a network path from path computation engine 302 that may be optimized according to different criteria, such as bandwidth, cost, etc. When the desired network path is identified, signaling module 306 may then communicate with respective nodes along the network path to establish the requested network services. In different embodiments, signaling module 306 may employ a signaling protocol to propagate subsequent communication to and from nodes along the network path.

In operation of control system 300, transmission parameters for one or more superchannels may be calculated when a desired optical network path has been provisioned. The transmission parameters may include a baud rate for each subcarrier. In this manner, mixed baud rate subcarriers may be implemented in a superchannel, as described herein.

Referring now to FIG. 4A, selected elements of an embodiment of a superchannel is shown as superchannel power spectrum 400, which depicts four (4) subcarriers subject to PBN 402. As shown in FIG. 4, the subcarriers, at center frequencies f₁, f₂, f₃, and f₄, are depicted in simplified form for descriptive clarity, yet may still be substantially similar to the subcarrier bands depicted in simulated frequency spectrum 200 (see FIG. 2). In superchannel power spectrum 400, the edge subcarriers (in reference to their edge positions within the superchannel) have been modified to decrease their baud rate, and are shown as subcarriers 404-1 and 404-4, while the unmodified versions of subcarriers 404-1 and 404-4 are shown in grey, respectively. As a result of the decreased baud rate of subcarriers 404-1 and 404-4, the superchannel may be less susceptible to degradation from PBN 402, which may result from the superchannel being passed through one or more ROADM nodes along a particular optical transmission path. Thus, the superchannel in power spectrum 400 may have somewhat narrower bandwidth and may be more tolerant to PBN 402. Because of the larger spectral spacing between subcarriers pairs (f₁, f₂) and (f₃, f₄) due to the decreased baud rate for subcarriers 404-1 (f₁) and 404-4 (f₄), smaller nonlinear effects on subcarriers at f₂ and f₃ may be observed. In addition, the OSNR penalties may be equalized among all the subcarriers, which is desirable.

Although the example spectra of a superchannel depicted below in FIGS. 4-7 are shown with 4 subcarrier bands, it is noted that the methods described herein may be practiced on superchannels having different numbers of subcarrier bands. For example, when the superchannel may have an even number of subcarriers, such as 4, 6, 8, 10, etc. Also, in instances where a number of baud rate-modified subcarriers is four or more, a magnitude of the baud rate modification may depend on a position of a subcarrier within the superchannel. In various embodiments, when mixed baud rate subcarriers are used with a superchannel, as described herein, the baud rates may be symmetrical with respect to the spectral position within the superchannel. So, for example, subcarriers at f₁ and f₄ may have a first baud rate (unmodified, increased, or decreased), while subcarriers at f₂ and f₃ may have a second baud rate (unmodified, increased, or decreased).

Referring now to FIG. 4B, selected elements of an embodiment of a superchannel is shown as superchannel power spectrum 401, which depicts four (4) subcarriers at center frequencies f₁, f₂, f₃, and f₄. In power spectrum 401, PBN 403 does not limit the overall bandwidth of the superchannel, in contrast to PBN 402 shown in FIG. 4A. Thus, in power spectrum 401 prior to modification of subcarrier baud rates, nonlinear effects may dominate the OSNR penalties for subcarriers at f₂ and f₃. In superchannel power spectrum 401, subcarriers 404-1 (f₁) and 404-4 (f₄) have been modified to decrease their baud rate, while the unmodified versions of subcarriers 404-1 and 404-4 are shown in grey, respectively. Additionally, a slight frequency shift Δf has been applied outward toward the edges of power spectrum 401 to subcarriers 404-1 and 404-4. As a result of the decreased baud rate for subcarriers 404-1 (f₁) and 404-4 (f₄) and the frequency shift Δf, the superchannel may be less susceptible to OSNR penalties for subcarriers at f₂ and f₃. In this manner, the OSNR penalties among all the subcarriers in the superchannel may be equalized, which is desirable.

Referring now to FIG. 5, selected elements of an embodiment of a superchannel is shown as superchannel power spectrum 500, which depicts four (4) subcarriers at center frequencies f₁, f₂, f₃, and f₄. In power spectrum 500, PBN 502 does not limit the overall bandwidth of the superchannel, in contrast to PBN 402 shown in FIG. 4A. Thus, in power spectrum 500 prior to modification of subcarrier baud rates, nonlinear effects may dominate the OSNR penalties for subcarriers at f₂ and f₃ In superchannel power spectrum 500, subcarriers 504-2 (f₂) and 504-3 (f₃) have been modified to decrease their baud rate, while the unmodified versions of subcarriers 504-2 and 504-3 are shown in grey, respectively. As a result of the decreased baud rate for subcarriers 504-2 (f₂) and 504-3 (f₃), the superchannel may be less susceptible to OSNR penalties for subcarriers at f₂ and f₃. In this manner, the OSNR penalties among all the subcarriers in the superchannel may be equalized, which is desirable.

Referring now to FIG. 6, selected elements of an embodiment of a superchannel is shown as superchannel power spectrum 600, which depicts four (4) subcarriers at center frequencies f₁, f₂, f₃, and f₄. In power spectrum 600, PBN 602 does not limit the overall bandwidth of the superchannel, in contrast to PBN 402 shown in FIG. 4A. Thus, in power spectrum 600 prior to modification of subcarrier baud rates, nonlinear effects may dominate the OSNR penalties for subcarriers at f₂ and f₃. In superchannel power spectrum 600, subcarriers 604-2 (f₂) and 604-3 (f₃) have been modified to increase their baud rate, while subcarriers 604-1 (f₁) and 604-4 (f₄) have been modified to decrease their baud rate. The unmodified versions of the subcarriers are shown in grey, respectively. Additionally in power spectrum 600, the frequencies f₁, f₂, f₃, and f₄ have been shifted slightly towards the edges of the superchannel. Specifically, the frequencies f₁ and f₄ have been shifted outward by a first frequency shift, while the frequencies f₂ and f₃ have been shifted outward by a second frequency shift. The first and second frequency shifts in power spectrum 600 may depend on an actual amount of baud rate modification performed respectively per subcarrier or groups of subcarriers. As in the previous examples, the OSNR penalties among all the subcarriers in the superchannel may be equalized, which is desirable.

Additionally, in contrast to power spectra 400, 401, and 500 in which the overall baud rate for the superchannel was decreased due to baud rate decreases, the overall baud rate for the superchannel in power spectra 600 may be maintained. For example, when the unmodified baud rate for each subcarrier of the four (4) subcarriers is 32 Gbaud, the overall baud rate for the superchannel will be 128 Gbaud. When, as in power spectra 400, 401, and 500, the baud rate of the modified two (2) subcarriers is decreased to 16 Gbaud, the overall baud rate for the superchannel will be 96 Gbaud. However, in power spectra 600, when subcarriers 604-2 (f₂) and 604-3 (f₃) have been modified to increase the baud rate to 40 Gbaud, while subcarriers 604-1 (f₁) and 604-2 (f₄) have been modified to decrease the baud rate to 24 Gbaud, the overall baud rate of the superchannel will remain at 128 Gbaud. Maintaining the same overall baud rate for the superchannel may be economically advantageous by avoiding reduced overall data throughput, which is desirable.

Referring now to FIG. 7, selected elements of an embodiment of a superchannel is shown as superchannel power spectrum 700, which depicts four (4) subcarriers at center frequencies f₁, f₂, f₃, and f₄. In power spectrum 700, PBN 702 does not limit the overall bandwidth of the superchannel, in contrast to PBN 402 shown in FIG. 4A. Thus, in power spectrum 700 prior to modification of subcarrier baud rates, nonlinear effects may dominate the OSNR penalties for subcarriers at f₂ and f₃ In superchannel power spectrum 700, subcarriers 704-2 (f₂) and 704-3 (f₃) have been modified to decrease their baud rate, while subcarriers 704-1 (f₁) and 704-4 (f₄) have been modified to increase their baud rate. The unmodified versions of the subcarriers are shown in grey, respectively. Additionally in power spectrum 700, the frequencies f₁, f₂, f₃, and f₄ have been shifted slightly towards a center frequency of the superchannel. Specifically, the frequencies f₁ and f₄ have been shifted inwards toward the center by a first frequency shift, while the frequencies f₂ and f₃ have been shifted inward by a second frequency shift. The first and second frequency shifts in power spectrum 700 may depend on an actual amount of baud rate modification performed respectively per subcarrier or groups of subcarriers. As in the previous examples, the OSNR penalties among all the subcarriers in the superchannel may be equalized, which is desirable. As noted above for power spectrum 600, the overall baud rate for the superchannel in power spectrum 700 may be maintained without reduction of overall data throughput, which is desirable.

Although in power spectra 400, 401, 500, 600 and 700 only four (4) subcarriers are depicted for descriptive clarity, it is noted that different and additional numbers of subcarriers may be used with the methods and systems described herein for transmission of superchannels with mixed baud rate subcarriers.

In one example embodiment, with five (5) subcarriers at frequencies f₁, f₂, f₃, f₄, and f₅, the baud rate of the subcarriers at f₁ and f₅ may be modified to be the same or smaller than the baud rate of the subcarriers at f₂ and f₄, while the baud rate of center subcarrier f₃ in this example may remain unmodified. Additionally, the frequencies f₁ and f₅ may be shifted towards the edges of the superchannel by a first frequency shift that is the same or greater than a second frequency shift that the frequencies f₂ and f₄ may be shifted towards the edges of the superchannel, while the frequency of f₃ may remain unchanged.

In another example embodiment, with five (5) subcarriers at frequencies f₁, f₂, f₃, f₄, and f₅, the baud rate of the subcarriers at f₁ and f₅ may remain unmodified. The baud rate of center subcarrier f₃ may be modified to be the same or smaller than the baud rate of the subcarriers at f₂ and f₄ Additionally, the frequencies f₂ and f₄ may be shifted towards the edges of the superchannel by a frequency shift, while the frequency of f₃ may remain unchanged.

Similar approaches may be used for other numbers of subcarriers, odd or even, where subcarriers are symmetrically modified in terms of baud rate, with or without a commensurate frequency shift, based on a position of a subcarrier within the superchannel. It is noted that while baud rates and individual subcarrier frequencies may be modified, as described herein, the overall bandwidth of the superchannel may remain fixed and may comply with relevant ITU transmission standards.

In some embodiments with superchannels having larger numbers of subcarriers, certain adjacent subcarriers may be grouped into subcarrier bands. Each subcarrier in a subcarrier band may be assigned a common baud rate, with or without a given frequency shift. For example, Table 1 below shows baud rate assignments for a superchannel with 10 subcarriers and 5 subcarrier bands of two subcarriers each.

TABLE 1
Example of subcarrier bands in a superchannel

| Subcarrier | Subcarrier | Baud |
|---|---|---|
| Frequency | Band | Rate |
| f₁ | A | BR1 |
| f₂ | A | BR1 |
| f₃ | B | BR2 |
| f₄ | B | BR2 |
| f₅ | C | BR3 |
| f₆ | C | BR3 |
| f₇ | D | BR2 |
| f₈ | D | BR2 |
| f₉ | E | BR1 |
| f₁₀ | E | BR1 |

In Table 1, subcarrier bands A and E have baud rate BR1, subcarrier bands B and D have baud rate BR2, while subcarrier band C has baud rate BR 3. The baud rates may be modified as described in the previous examples, either by decreasing the baud rate or increasing the baud rate. Additionally, frequency shifts may be applied on a per subcarrier band basis, for example, when PBN is not limiting, as described in the previous examples.

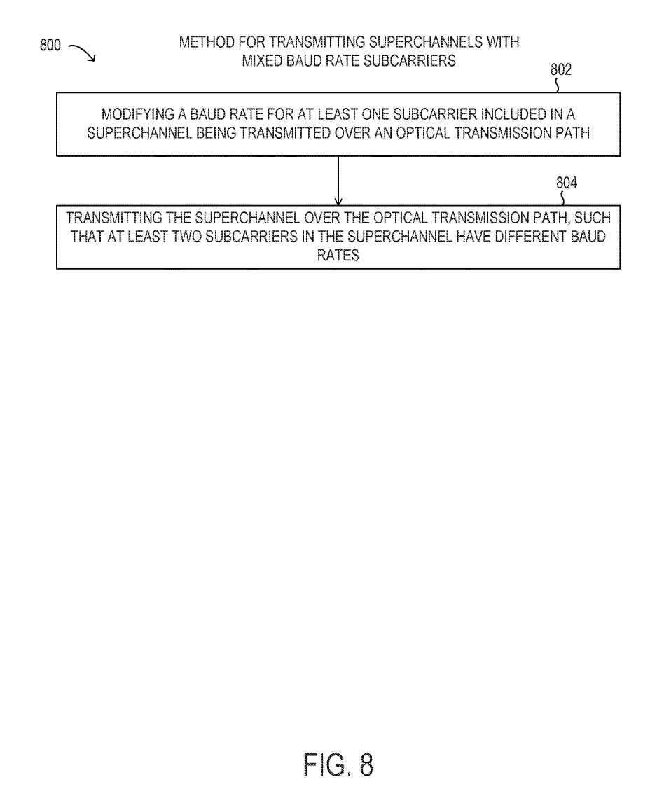

Referring now to FIG. 8, a block diagram of selected elements of an embodiment of method 800 for transmitting superchannels with mixed baud rate subcarriers, as described herein, is depicted in flowchart form. Method 800 may be performed using optical transport network 101. In some embodiments, network management system 300 may be used to determine modified baud rates and associated frequency shifts, as well as for communicating the baud rates and frequency shifts to components in optical transport network 101, as described above. It is noted that certain operations described in method 800 may be optional or may be rearranged in different embodiments.

Method 800 may begin at step 802 by modifying a baud rate for at least one subcarrier included in a superchannel being transmitted over an optical transmission path. At step 802, an FEC module may be used to modify the baud rate. At step 802, an optical transmitter may be used to modify the baud rate. At step 802, the baud rate may be decreased. At step 802, the baud rate may be increased. At step 802, an overall baud rate for the superchannel may be decreased. At step 802, an overall baud rate for the superchannel may be maintained. At step 802, modifying the baud rate may depend upon a spectral position of a subcarrier in the superchannel. At step 802, the baud rate may be symmetrically modified with respect to spectral positions of the subcarriers within the superchannel. At step 802, the baud rate may be set for a subcarrier band comprising at least two spectrally adjacent subcarriers. At step 804, the superchannel may be transmitted over the optical transmission path, such that at least two subcarriers in the superchannel have different baud rates.

As disclosed herein, methods and systems for transmitting superchannels with mixed baud rate subcarriers include modifying baud rates for certain subcarriers in order to improve or equalize optical signal-to-noise ratio penalties incurred during transmission. Additionally frequency shifts may be applied to individual subcarriers. The baud rate modification and frequency shifts may be symmetrical for spectral positions of subcarriers within the superchannel.

While the subject of this specification has been described in connection with one or more exemplary embodiments, it is not intended to limit any claims to the particular forms set forth. On the contrary, any claims directed to the present disclosure are intended to cover such alternatives, modifications and equivalents as may be included within their spirit and scope.

What is claimed is:

1. A method for transmitting superchannels with mixed baud rate subcarriers, the method comprising:
for a superchannel being transmitted over an optical transmission path, modifying a baud rate for at least one subcarrier included in the superchannel; and
after the modifying, transmitting the superchannel over the optical transmission path, wherein at least two subcarriers in the superchannel have different baud rates.

2. The method of claim 1, wherein the modifying the baud rate further comprises:
using a forward error correction module to modify the baud rate.

3. The method of claim 1, wherein the modifying the baud rate further comprises:
using an optical transmitter to modify the baud rate.

4. The method of claim 1, wherein the modifying the baud rate further comprises:
decreasing the baud rate.

5. The method of claim 1, wherein the modifying the baud rate further comprises:
increasing the baud rate.

6. The method of claim 1, wherein the modifying the baud rate further comprises:
decreasing an overall baud rate for the superchannel.

7. The method of claim 1, wherein the modifying the baud rate further comprises:
maintaining an overall baud rate for the superchannel.

8. The method of claim 1, wherein the modifying the baud rate depends upon a spectral position of a subcarrier in the superchannel.

9. The method of claim 8, wherein the modifying the baud rate further comprises:
modifying the baud rate symmetrically with respect to spectral positions of the subcarriers within the superchannel.

10. The method of claim 1, wherein the modifying the baud rate further comprises:
setting the baud rate for a subcarrier band comprising at least two spectrally adjacent subcarriers.

11. An optical transport network for transmitting superchannels with mixed baud rate subcarriers, the optical transport network comprising:
an optical transmission path, including an optical transmitter and an optical receiver, for transmitting a superchannel, wherein a baud rate is modified for at least one subcarrier included in the superchannel, such that at least two subcarriers in the superchannel have different baud rates.

12. The optical transport network of claim 11, wherein the baud rate is modified using a forward error correction module prior to the optical transmitter along the optical transmission path.

13. The optical transport network of claim 11, wherein the baud rate is modified using the optical transmitter.

14. The optical transport network of claim 11, wherein the baud rate is modified to decrease the baud rate.

15. The optical transport network of claim 11, wherein the baud rate is modified to increase the baud rate.

16. The optical transport network of claim 11, wherein after the baud rate is modified, an overall baud rate for the superchannel is decreased.

17. The optical transport network of claim 11, wherein after the baud rate is modified, an overall baud rate for the superchannel is maintained.

18. The optical transport network of claim 11, wherein the baud rate is modified based upon a spectral position of a subcarrier in the superchannel.

19. The optical transport network of claim 18, wherein the baud rate is modified symmetrically with respect to spectral positions of the subcarriers within the superchannel.

20. The optical transport network of claim 11, wherein the baud rate is modified to set the baud rate for a subcarrier band comprising at least two spectrally adjacent subcarriers.
